(19) United States
(12) Patent Application Publication
(10) Pub. No.: US 2016/0319903 A1
(43) Pub. Date: Nov. 3, 2016

(54) INTERLOCK FOR RING GEAR ON A FLYWHEEL

(71) Applicant: Schaeffler Technologies AG & Co. KG, Herzogenaurach (DE)

(72) Inventors: Raymundo Juan Lien Chang, Puebla (MX); Gabriela Guerra Galan, Puebla (MX); Carlos Hidalgo Rosete, Puebla (MX)

(21) Appl. No.: 14/699,669

(22) Filed: Apr. 29, 2015

(51) Int. Cl. F16F 15/30; F16H 55/17

(52) U.S. Cl. CPC F16F 15/30; F16H 55/17

(57) ABSTRACT

A flywheel assembly, including: an axis of rotation; a flywheel arranged for connection to an engine and including a radially outermost portion; a ring gear in contact with the radially outermost portion and forming a radially outermost portion of the flywheel assembly; and a connection assembly arranged to block displacement of the ring gear, with respect to the flywheel, in a first axial direction.

### TECHNICAL FIELD

The present disclosure relates generally to an assembly for preventing separation of a ring gear from a flywheel, in particular, a connection assembly including blocking elements fixedly secured to the flywheel by fasteners and axially aligned with the ring gear.

### BACKGROUND

FIG. 6 is a partial cross-sectional view of prior art flywheel FW and ring gear RG. FIG. 7A is a cross-sectional view generally along line 7-7 in FIG. 6 showing ring gear RG axially displaced against flywheel FW. FIG. 7B is a cross-sectional view generally along line 7-7 in FIG. 6 showing ring gear RG axially displaced and partially disengaged with flywheel FW. Ring gear RG is designed to engage a starter motor to receive torque from the starter motor to start and engine connected to flywheel FW. Thus, ring gear RG must be non-rotatably connected to flywheel FW. Typically, ring gear RC is heated, to radially expand ring gear RG, and placed about flywheel FW in step ST of the flywheel. Upon cooling, ring gear RG compressively engages flywheel FW to secure ring gear RG to flywheel FW as shown in FIG. 7A. However, during operation of the engine, ring gear RG can be sufficiently heated to cause radially outward expansion of ring gear RG. This expansion can loosen the compressive engagement of ring gear RG with flywheel FW and enable axial displacement of ring gear RG in axial direction A, creating gap G, as shown in FIG. 7B

The displacement in axial direction A can have several undesirable impacts. For example, as shown in FIG. 7B, ring gear RG can displace far enough in direction A that portions of surface S2 of ring gear RG disengage from surface S1 of flywheel FW. In a worst case, all of surface S2 disengages from surface S1. In the first case, the non-rotatable connection of ring gear RG and flywheel FW can be negatively impacted so that ring gear RG rotates independent of flywheel FW or sporadically grips and rotates with flywheel FW. In the second case, ring gear RG rotates independent of flywheel FW. As a result, the starter and ring gear RG may have difficulty starting the engine or may be unable to start the engine. Further, if ring gear RG is no long anchored in place, ring gear RG may impact and damage other engine components.

### SUMMARY

The present disclosure broadly comprises a flywheel assembly, including: an axis of rotation; a flywheel arranged for connection to an engine and including a radially outermost portion; a ring gear in contact with the radially outermost portion and forming a radially outermost portion of the flywheel assembly; and a connection assembly arranged to block displacement of the ring gear, with respect to the flywheel, in a first axial direction.

The present disclosure broadly comprises a flywheel assembly, including: a flywheel arranged for connection to an engine and including a radially outermost portion; a ring gear in contact with the radially outermost portion and forming a radially outermost portion of the flywheel assembly; and a connection assembly including a plurality of blocking elements arranged to block displacement of the ring gear, with respect to the flywheel, in a first axial direction.

The present disclosure broadly comprises a flywheel assembly, including: a flywheel arranged for connection to an engine and including a radially outermost portion; a ring gear in contact with the radially outermost portion and forming a radially outermost portion of the flywheel assembly; and a connection assembly. The connection assembly includes: a plurality of blocking elements including respective first portions axially aligned with the ring gear and arranged to block displacement of the ring gear, with respect to the flywheel, in a first axial direction; and a plurality of fastening elements fixedly connecting the plurality of blocking elements to the flywheel.

### BRIEF DESCRIPTION OF THE DRAWINGS

The nature and mode of operation of the present disclosure will now be more fully described in the following detailed description of the present disclosure taken with the accompanying figures, in which:

FIG. 1 it is a perspective view of a cylindrical coordinate system demonstrating spatial terminology used in the present application;

FIG. 2 is a front view of a flywheel assembly with an interlock for a ring gear;

FIG. 3 is a detail of area 3 in FIG. 2

FIG. 4A is a cross-sectional view generally along line 4-4 in FIG. 2 showing the ring gear axially displaced against the flywheel;

FIG. 4B is a cross-sectional view generally along line 4-4 in FIG. 2 showing the ring gear axially displaced against the interlock;

FIG. 5 is a side view of area 3 in FIG. 2;

FIG. 6 is a front view of a prior art flywheel with a ring gear;

FIG. 7A is a cross-sectional view generally along line 7-7 in FIG. 6 showing the ring gear axially displaced against the flywheel; and,

FIG. 7B is a cross-sectional view generally along line 7-7 in FIG. 6 showing the ring gear axially displaced and partially disengaged with the flywheel.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”. “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

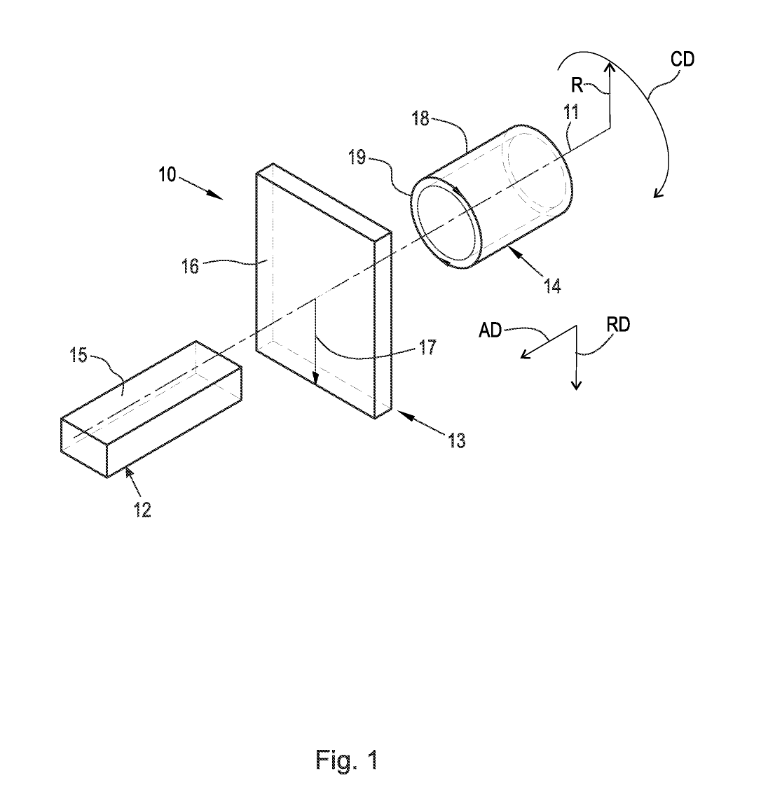

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow, Axial direction AD is parallel to axis 11, Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

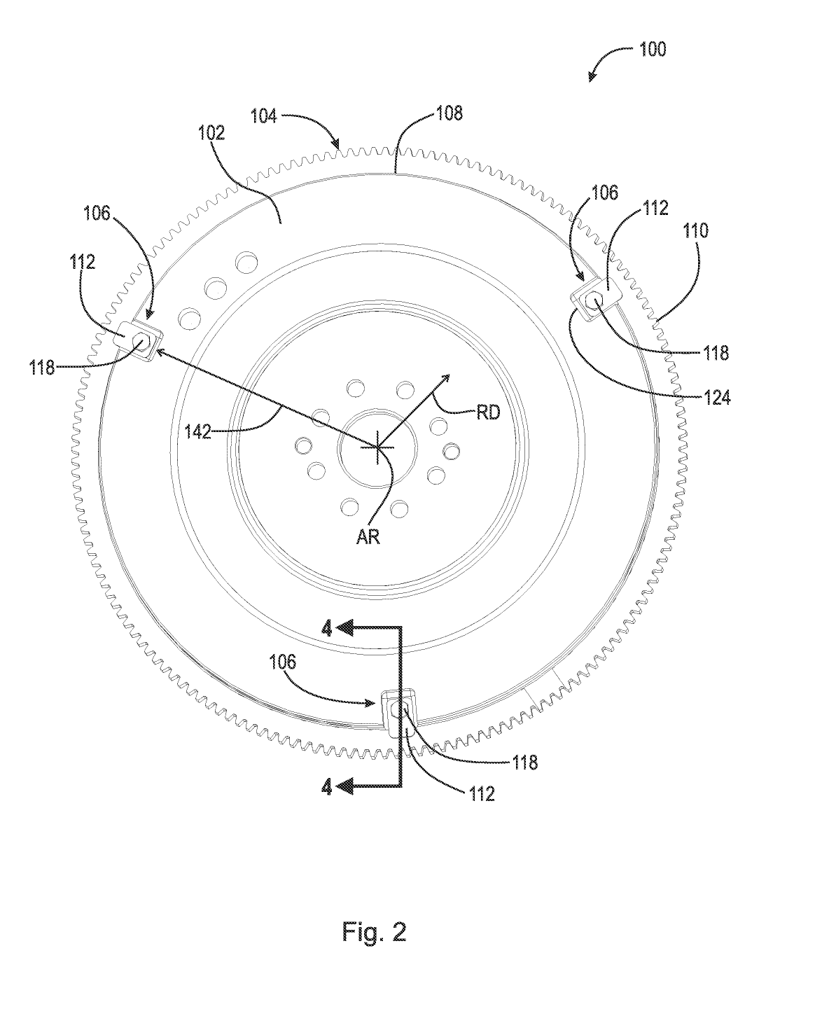

FIG. 2 is a front view of flywheel assembly 100 with an interlock for a ring gear.

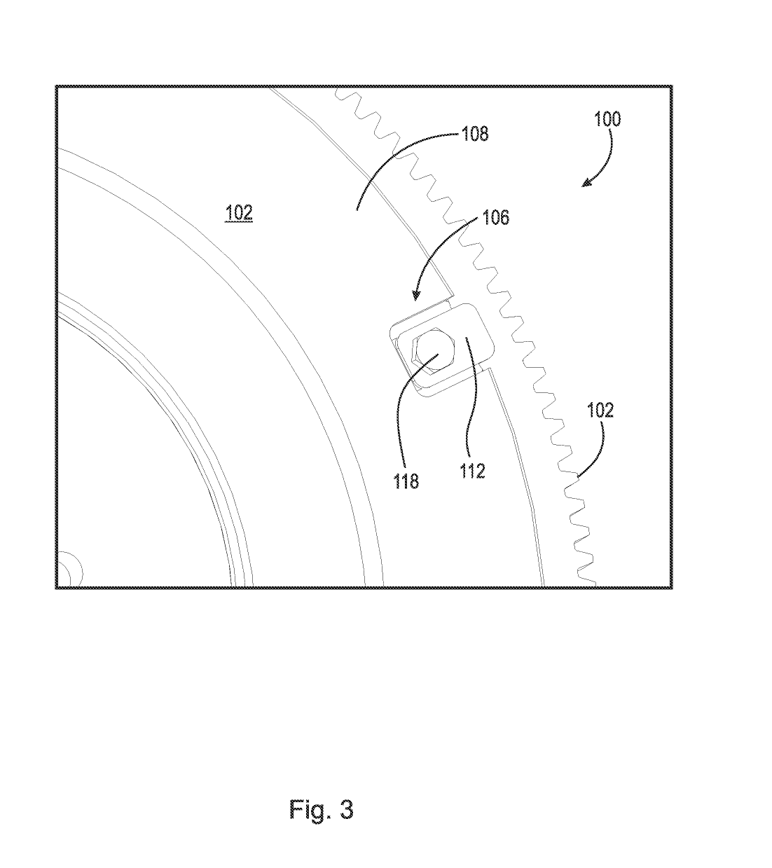

FIG. 3 is a detail of area 3 in FIG. 2,

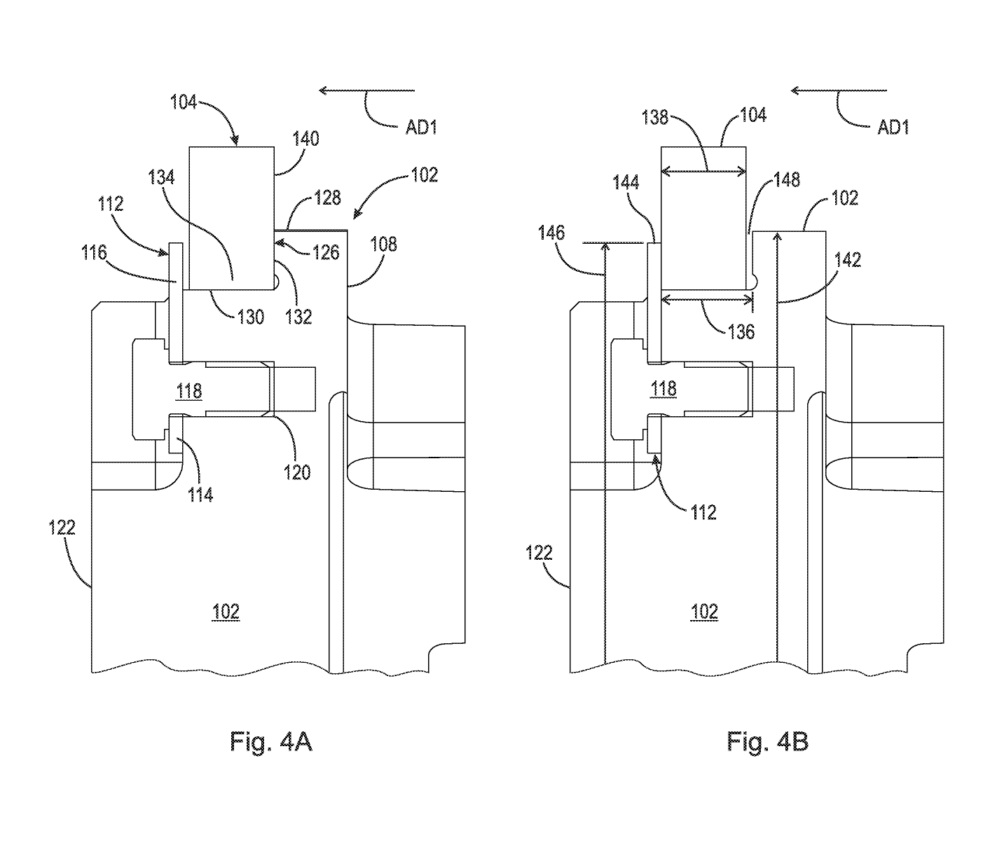

FIG. 4A is a cross-sectional view generally along line 4-4 in FIG. 2 showing the ring gear axially displaced against the flywheel,

FIG. 4B is a cross-sectional view generally along line 4-4 in FIG. 2 showing the ring gear axially displaced against the interlock.

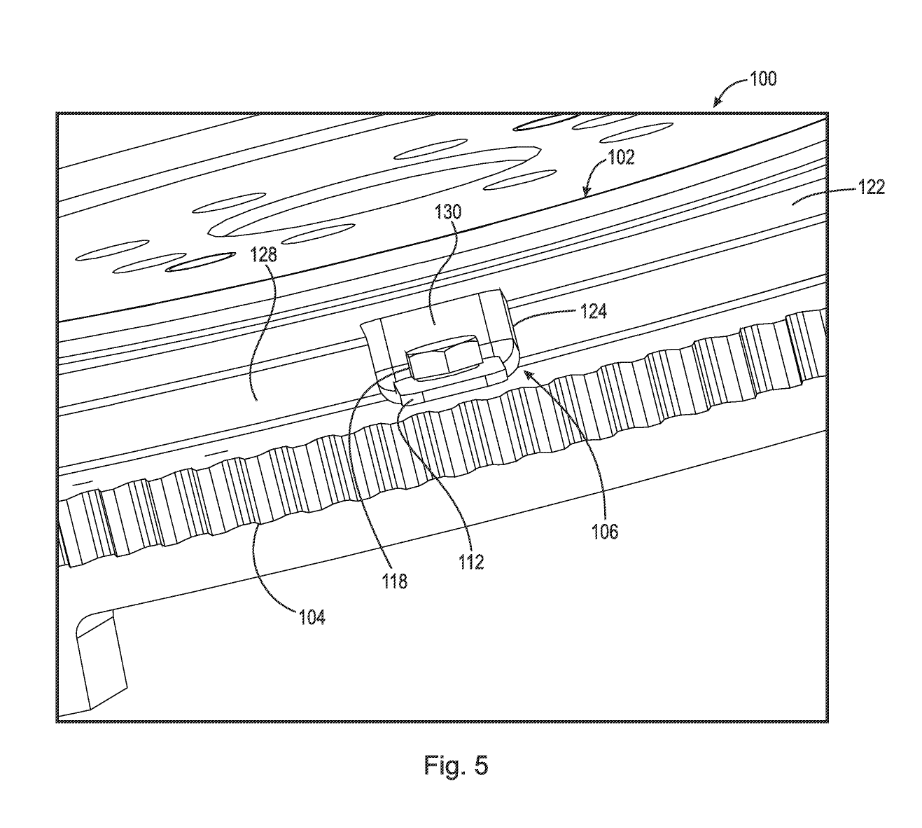

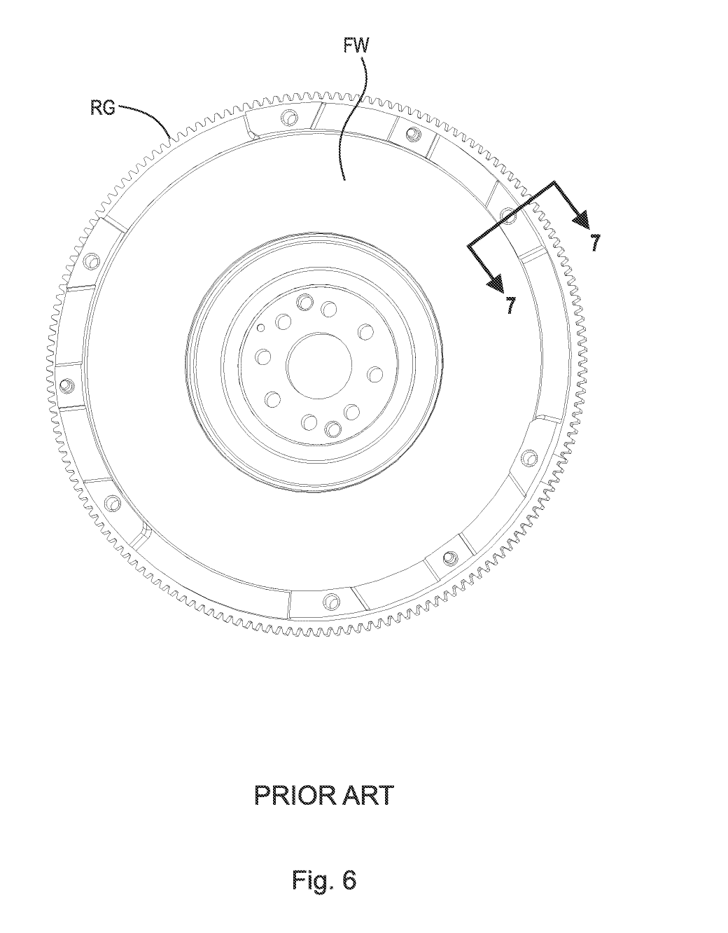

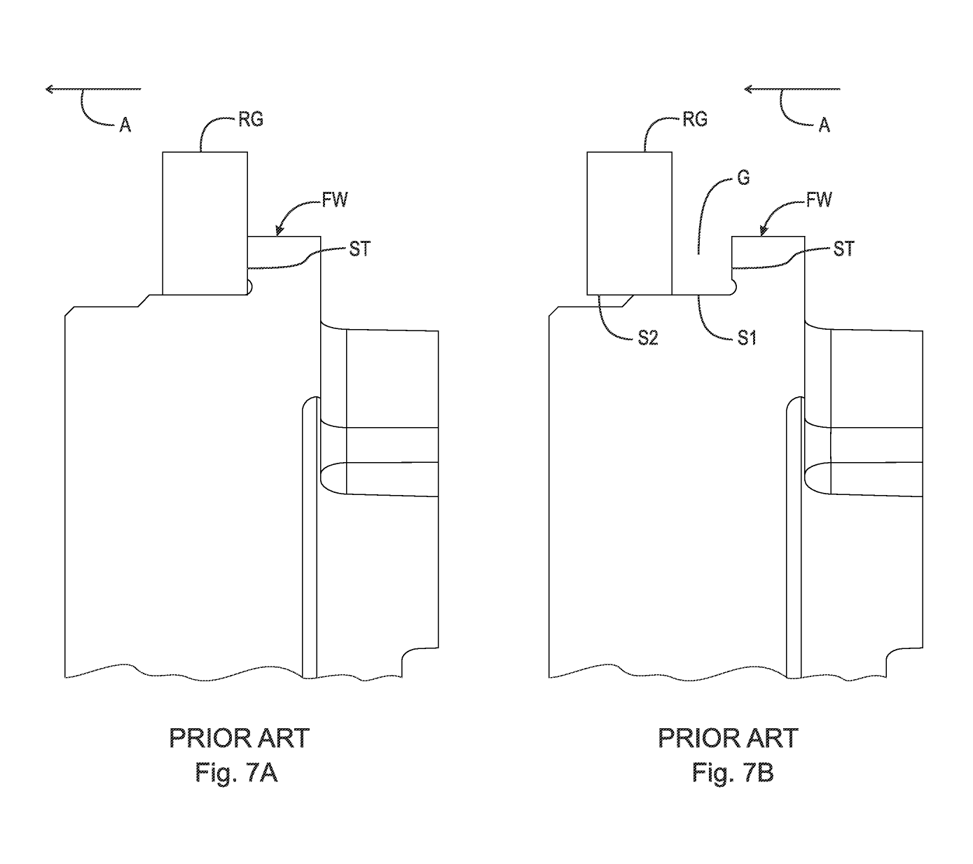

FIG. 5 is a side view of area 3 in FIG. 2. The following should be viewed in light of FIGS. 2 through 5. Flywheel assembly 100 includes axis of rotation AR, flywheel 102, ring gear 104 and connection assembly 106. Flywheel 102 is arranged for connection to an engine (not shown) and includes radially outermost portion 108. Ring gear 104 is in contact with radially outermost portion 108 and forms radially outermost portion 110 of flywheel assembly 100. Connection assembly 106 is arranged to block displacement of ring gear 104, with respect to flywheel 102, in axial direction AD1.

Connection assembly 106 includes blocking elements 112. Each blocking element 112 includes: portion 114 fixedly connected to flywheel 102; and portion 116 aligned with ring gear 104 in the axial direction AD1. In an example embodiment, connection assembly 106 includes fastening elements 118. Each fastening element 118 passes through a respective portion 114 and clamps the respective portion 114 to the flywheel. In an example embodiment, elements 118 are threaded fasteners threaded into threaded openings 120 in the flywheel. Each blocking element 112 is formed by a respective piece of material separate from material forming the flywheel or the ring gear. That is, elements 112 are not integrally formed with the flywheel or the ring gear.

In an example embodiment, flywheel 102 includes: side 122 facing in axial direction. AD1; and indentations 124 in side 122. Each respective portion 114 is disposed in a respective indentation 124. Indentations 124 open radially outward, In an example embodiment (not shown), portions 114 are engaged directly with side 122 (there are no indentations in side 122 receiving fastening elements 118.

In an example embodiment, radially outermost portion 108 includes circumferentially disposed step 126 including surfaces 128, 130 and 132. Surface 128 faces radially outward in radial direction RD and forms an outer circumference of flywheel 102. Surface 130 faces radially outward in direction RD and is located radially inward of surface 128. Surface 132 faces in axial direction AD1 and connecting surfaces 128 and 130. Ring gear 104 is disposed in step 126. Ring gear 104, in particular, radially innermost surface 134, is in contact with surface 130. In an example embodiment: surface 130 has extent 136 in axial direction AD1; and ring gear 104 has extent 138, less extent 136, in axial direction AD1. In an example embodiment, ring gear 104, in particular, side 140, is in contact surface 128.

In an example embodiment: surface 128 is at radial distance 142 from axis of rotation AR; and each blocking element 112 includes radially outermost edge 144 at radial distance 146, no greater than the radial distance 142, from axis of rotation AR. Radial distances 142 and 146 are selected to prevent interference with a gear (not shown) for starter motor (not shown) for the engine, which engages ring gear 104 to start the engine.

In an example embodiment, assembly 106 includes three blocking elements 114 and three fasteners 118 equally circumferentially disposed about the flywheel. However, it should be understood that other numbers of blocking elements 114 and fasteners 118 can be used with assembly 100.

Advantageously, assembly 100 removes the problems noted above related to undesired displacement of ring gear 104 with respect to flywheel 102. Ring gear 104 can be heated as noted above and placed about flywheel 102 to then cool down and compressively engage flywheel 102. However, if ring gear 104 is sufficiently heated during operation of the engine, blocking elements 112 prevent displacement of ring gear 104 past step 126 in axial direction AD1 as shown in FIG. 4B. That is, although gap 148 may form, elements 112 prevent ring gear from partially or totally disengaging from flywheel 102. Thus, when ring gear 104 cools down, the full extent of surfaces 128 and 134 remain in contact and compressively engaged. Further, assembly 106 does not interfere with the normal operations for mounting ring gear 104 to flywheel 102. Specifically, ring gear is heated and placed about flywheel 102 and afterward, blocking elements 114 are connected to flywheel 102 by fasteners 118.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A flywheel assembly, comprising:
a flywheel:
arranged for connection to an engine; and,
including a radially outermost portion;
a ring gear:
in contact with the radially outermost portion; and,
forming a radially outermost portion of the flywheel assembly; and,
a connection assembly arranged to block displacement of the ring gear, with respect to the flywheel, in a first axial direction.

2. The flywheel assembly of claim 1, wherein:
the connection assembly includes a plurality of blocking elements;
each blocking element included in the plurality of blocking elements includes:
a first portion fixedly connected to the flywheel; and,
a second portion aligned with the ring gear in the first axial direction.

3. The flywheel assembly of claim 3, wherein:
the connection assembly includes a plurality of fastening elements;
each fastening element:
passes through a respective first portion of said each blocking element; and,
clamps the respective first portion to the flywheel.

4. The flywheel assembly of claim 3, wherein said each fastening element is a respective threaded fastener.

5. The flywheel assembly of claim 3, wherein:
the flywheel includes:
a first side facing in the first axial direction; and,
a plurality of indentations in the first side;
each respective first portion is disposed in a respective indentation included in the plurality of indentations.

6. The flywheel assembly of claim 3, wherein:
said each blocking element is formed by a respective piece of material separate from material forming the flywheel or the ring gear.

7. The flywheel assembly of claim 3, wherein:
the radially outermost portion includes a circumferentially disposed step including:
a first surface facing radially outward and forming an outer circumference of the flywheel;
a second surface facing radially outward and located radially inward of the first surface; and,
a third surface facing in the first axial direction and connecting the first and second surfaces; and,
the ring gear is disposed in the step.

8. The flywheel assembly of claim 7, wherein:
the ring gear is in contact with the second surface;
the second surface has a first extent in the first axial direction; and,
the ring gear has a second extent, less than the first extent, in the first axial direction,

9. The flywheel assembly of claim 7, wherein the ring gear is in contact with the first surface.

10. The flywheel assembly of claim 7, wherein:
the first surface is at a first radial distance from an axis of rotation for the flywheel; and,
said each blocking element includes a radially outermost edge at a second radial distance, no greater than the first radial distance, from the axis of rotation.

11. A flywheel assembly, comprising:
an axis of rotation,
a flywheel:
arranged for connection to an engine; and,
including a radially outermost portion;
a ring gear:
in contact with the radially outermost portion; and,
forming a radially outermost portion of the flywheel assembly; and,
a connection assembly including a plurality of blocking elements arranged to block displacement of the ring gear, with respect to the flywheel, in a first axial direction.

12. The flywheel assembly of claim 11, wherein:
each blocking element included in the plurality of blocking elements includes:
a first portion fixedly connected to the flywheel; and,
a second portion aligned with the ring gear in the first axial direction.

13. The flywheel assembly of claim 12, wherein:
the connection assembly includes a plurality of fastening elements;
each fastening element:
passes through a respective first portion of said each blocking element; and,
clamps the respective first portion to the flywheel.

14. The flywheel assembly of claim 13, wherein:
the flywheel includes:
a first side facing in the first axial direction; and,
a plurality of indentations in the first side;
each respective first portion is disposed in a respective indentation included in the plurality of indentations.

15. The flywheel assembly of claim 13, wherein:
the radially outermost portion includes a circumferentially disposed step including:
a first surface facing radially outward and forming an outer circumference of the flywheel;
a second surface facing radially outward and located radially inward of the first surface; and,
a third surface facing in the first axial direction and connecting the first and second surfaces; and,
the ring gear is disposed in the step.

16. The flywheel assembly of claim 15, wherein:
the ring gear is in contact with the second surface;
the second surface has a first extent in the first axial direction; and,
the ring gear has a second extent, less than the first extent, in the first axial direction.

17. The flywheel assembly of claim 16, wherein the ring gear is in contact with the first surface.

18. A flywheel assembly, comprising:
an axis of rotation;
a flywheel:
arranged for connection to an engine; and,
including a radially outermost portion;
a ring gear:
in contact with the radially outermost portion; and,
forming a radially outermost portion of the flywheel assembly;
a connection assembly including:
a plurality of blocking elements:
including respective first portions axially aligned with the ring gear; and,
arranged to block displacement of the ring gear, with respect to the flywheel, in a first axial direction; and,
a plurality of fastening elements fixedly connecting the plurality of blocking elements to the flywheel.

19. The flywheel assembly of claim 18, wherein:
the flywheel includes:
a first side facing in the first axial direction; and,
a plurality of indentations in the first side;
each respective first portion is disposed in a respective indentation included in the plurality of indentations.

20. The flywheel assembly of claim 18, wherein:
the radially outermost portion includes a circumferentially disposed step including:
a first surface facing radially outward and forming an outer circumference of the flywheel;
a second surface facing radially outward and located radially inward of the first surface; and,
a third surface facing in the first axial direction and connecting the first and second surfaces; and,
the ring gear is in contact with the second surface.
